(19) United States
(12) Patent Application Publication
(10) Pub. No.: US 2004/0014408 A1
(43) Pub. Date: Jan. 22, 2004

(54) Method of mounting a rotating tool to a spindle

(76) Inventor: Kazuma Sekiya, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/052,518

(22) Filed: Jan. 23, 2002

(30) Foreign Application Priority Data
Jan. 24, 2001 (JP) 2001 - 15751

(51) Int. Cl. B26D 1/14

(52) U.S. Cl. 451/342; 83/666; 83/886; 83/698.41

(57) ABSTRACT

A method of detachably mounting a rotating tool provided with an attachment portion having a cylindrical inner circumferential surface (or outer circumferential surface) to a mounting portion having a cylindrical outer circumferential surface (or inner circumferential surface) of a spindle. The inner diameter (or outer diameter) at normal temperatures of the attachment portion is made larger (or smaller) than the outer diameter (or inner diameter) at normal temperatures of the mounting portion. The attachment portion is heated (or cooled) and/or the mounting portion is cooled (or heated) to make the inner diameter (or outer diameter) of the attachment portion larger (or smaller) than the outer diameter (or inner diameter) of the mounting portion to fit the mounting portion onto (or into) the attachment portion.

### FIELD OF THE INVENTION

The present invention relates to a method of mounting a rotating tool to a spindle and, more specifically, to a method of mounting a rotating tool provided with an attachment portion having a cylindrical inner or outer circumferential surface to a mounting portion having a cylindrical outer or inner circumferential surface of a spindle.

### DESCRIPTION OF THE PRIOR ART

In the production of semiconductor chips, a plurality of rectangular areas are defined by streets sectioned on the surface of a semiconductor wafer in a lattice form, and a semiconductor circuit is provided in each of the rectangular areas. The rectangular areas are separated from one another by cutting the semiconductor wafer along the streets to form semiconductor chips. A cutting machine which is also called “dicer” is used to cut the semiconductor wafer along the streets. The cutting machine comprises a spindle which is rotated at a high speed of about 30,000 to 60,000 rpm and a rotating tool which can be mounted to this spindle in such a manner that it can be exchanged, that is, attached or detached. The spindle is provided with a mounting portion having a cylindrical outer circumferential surface. The rotating tool comprises a hub and a thin annular cutting blade secured to the hub. The hub is provided with an attachment portion having a cylindrical inner circumferential surface. The cutting blade is formed by bonding together diamond grains with a suitable bond. The inner diameter of the inner circumferential surface of the attachment portion of the hub is set 5 to 10 μm larger than the outer diameter of the outer circumferential surface of the mounting portion of the spindle. The rotating tool is mounted to the spindle by fitting the attachment portion of the rotating tool onto the mounting portion of the spindle and then, constraining the rotating tool not to move relative to the spindle. The constraint of the rotating tool is effected, for example, by firmly sandwiching the rotating tool between the annular flange surface of the spindle and an annular constraining member detachably secured to the spindle.

The method of mounting the rotating tool to the spindle in the cutting machine of the prior art involves the following problems to be solved. Since the inner diameter of the inner circumferential surface of the attachment portion of the rotating tool is made slightly larger than the outer diameter of the outer circumferential surface of the mounting portion of the spindle, the rotating tool tends to become slightly eccentric from the spindle. Particularly when the spindle is rotated at a high speed, the eccentricity of the rotating tool from the spindle causes deterioration in cutting accuracy or cutting quality.

### SUMMARY OF THE INVENTION

It is therefore the principal object of the present invention to provide a method which enables a rotating tool to be mounted to a spindle by substantially avoiding the eccentricity of the rotating tool from the spindle.

According to an aspect of the present invention, the above principal object is attained by a method of detachably mounting a rotating tool provided with an attachment portion having a cylindrical inner circumferential surface to a mounting portion having a cylindrical outer circumferential surface of a spindle, comprising the steps of:

making the inner diameter at normal temperatures of the attachment portion smaller than the outer diameter at normal temperatures of the mounting portion; and

heating the attachment portion and/or cooling the mounting portion to make the inner diameter of the attachment portion larger than the outer diameter of the mounting portion so as to fit the attachment portion onto the mounting portion.

According to another aspect of the present invention, the above principal object is attained by a method of detachably mounting a rotating tool provided with an attachment portion having a cylindrical outer circumferential surface to a mounting portion having a cylindrical inner circumferential surface of a spindle, comprising the steps of:

making the outer diameter at normal temperatures of the attachment portion larger than the inner diameter at normal temperatures of the mounting portion; and

cooling the attachment portion and/or heating the mounting portion to make the outer diameter of the attachment portion smaller than the inner diameter of the mounting portion so as to fit the attachment portion into the mounting portion.

Preferably, at least the mounting portion of the spindle is made of metal and at least the attachment portion of the rotating tool is also made of metal. The method of the present invention is not limited to the method of mounting a rotating tool to a spindle in a cutting machine and hence, the rotating tool is not limited to a rotating tool having a cutting blade. In a preferred embodiment, however, the rotating tool has a metal hub and a thin annular cutting blade secured to the hub, the hub being provided with an attachment portion and the cutting blade containing diamond grains.

### BRIEF DESCRIPTION OF THE DRAWINGS

FIG. 1 is a schematic perspective view of a cutting machine to which the method of the present invention can be applied;

FIG. 2 is a perspective view of a semiconductor wafer to be cut by the cutting machine of FIG. 1 and mounted to a frame by an attachment tape;

FIG. 3 is a perspective view of a chuck means and a cutting means of the cutting machine of FIG. 1;

FIG. 4 is an exploded perspective view of a preferred embodiment of the relationship between a spindle and a rotating tool to be mounted to the spindle in the cutting means of the cutting machine of FIG. 1;

FIG. 5 is a sectional view of a preferred embodiment of the relationship between a spindle and a rotating tool mounted to the spindle in the cutting means of the cutting machine of FIG. 1;

FIG. 6 is an exploded perspective view showing a variation of the relationship between a spindle and a rotating tool to be mounted to the spindle; and

FIG. 7 is a sectional view showing a variation of the relationship between a spindle and a rotating tool mounted to the spindle.

### DETAILED DESCRIPTION OF THE PREFERRED EMBODIMENTS

Preferred embodiments of the present invention will be described in more detail hereinafter with reference to the accompanying drawings.

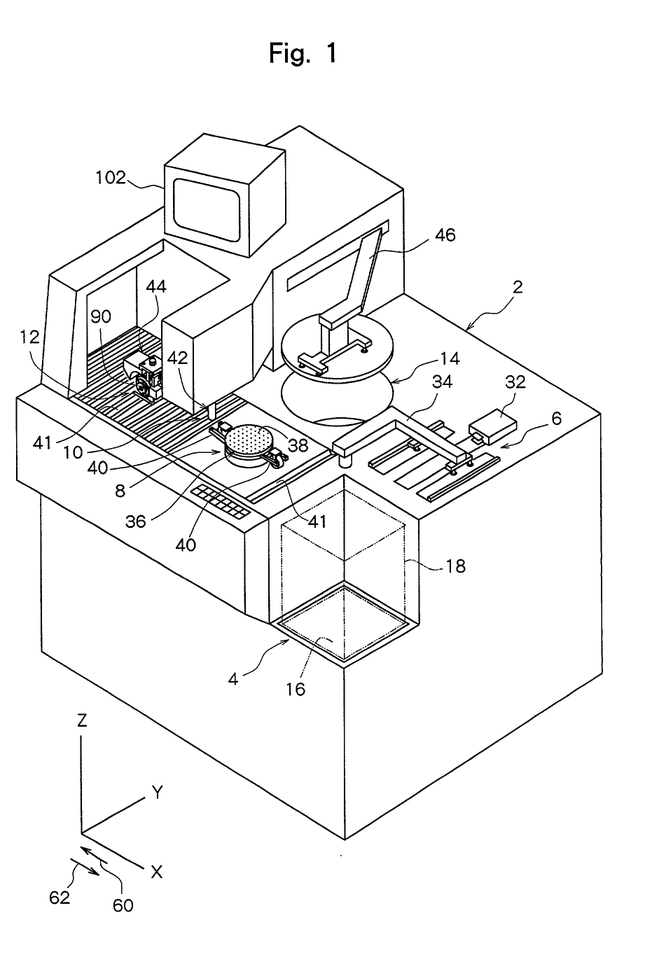

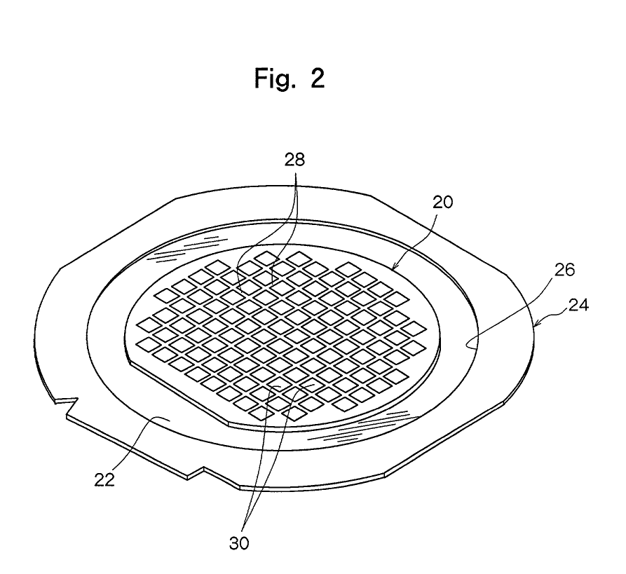

FIG. 1 shows a cutting machine to which the method of the present invention can be applied. The illustrated cutting machine has a housing 2, and on the housing 2, there are defined a loading area 4, a waiting area 6, a chucking area 8, an alignment area 10, a cutting area 12 and a cleaning/drying area 14. A lifting table 16 is provided in the loading area 4, and a cassette 18 is loaded on this lifting table 16. A plurality of semiconductor wafers 20 (FIG. 2) are stored, spaced from each other, in an up-and-down direction in this cassette 18.

As clearly shown in FIG. 2, each of the semiconductor wafers 20 stored in the cassette 18 is mounted on a frame 24 through an attachment tape 22. The frame 24 that can be formed of a metal or synthetic resin has a relatively large circular opening 26 at the central portion thereof, and the attachment tape 22 extending across the circular opening 26 is stuck onto the back surface of the frame 24. The semiconductor wafer 20 is positioned inside the circular opening 26 and the back surface thereof is stuck to the attachment tape 22. Streets 28 are arranged on the surface of the semiconductor wafer 20 in a lattice form to thereby define a plurality of rectangular regions 30. A semiconductor circuit is formed in each of the rectangular regions 30.

Continuing a description with reference to FIG. 1, a first conveying means 32 is provided in relation to the loading area 4 and the waiting area 6. The first conveying means 32 is actuated in response to the up-and-down movement of the lifting table 16 to carry-out the frames 24 mounting the semiconductor wafers 20 to be cut from the cassette 18 to the waiting area 6 sequentially (and as will be described later, to carry-in the frame 24 mounting the semiconductor wafer 20 that has been cut, cleaned and dried from the waiting area 6 to the cassette 18). A second carrying means 34 is provided in relation to the waiting area 6, the chucking area 8 and the cleaning/drying area 14. The frame 24 delivered from the cassette 18 to the waiting area 6 is conveyed to the chucking area 8 by the second conveying means 34. In the chucking area 8, the frame 24 and the semiconductor wafer 20 mounted thereon are held by a chuck means 36. Stated more specifically, the chuck means 36 has a chuck plate 38 having a substantially horizontal adsorption surface, and a plurality of suction holes or grooves are formed in the chuck plate 38. The semiconductor wafer 20 mounted on the frame 24 is placed on the chuck plate 38 and vacuum-adsorbed to the chuck plate 38. The chuck means 36 further has a pair of holding means 40 so that the frame 24 is held by the pair of holding means 40.

As will be described later, the chuck means 36 is caused to move in the first direction which is substantially horizontal, that is, in the X-axis direction, and the semiconductor wafer 20 held by the chuck means 36 is moved with the movement of the chuck means 36, and conveyed to the alignment area 10 and the cutting area 12 in sequence. In the illustrated embodiment, a bellows means 41 which is expanded or contracted with the movement of the chuck means 36 is provided on both sides (that is, downstream side and upstream side) of the chuck means 36 when seen from the X-axis direction. An alignment means 42 is provided in relation to the alignment area 10. In the alignment area 10, an image of the surface of the semiconductor wafer 20 held on the chuck means 36 is imaged and the semiconductor wafer 20 is adjusted to locate at a desired position fully accurately based on the image. Thereafter, in the cutting area 12, the semiconductor wafer 20 is cut along the streets 28 by action of a cutting means 44. Though the rectangular regions 30 are separated from one another by this cutting, the attachment tape 22 is not cut and the individually separated rectangular regions 30 continue to be mounted on the frame 24 via the attachment tape 22. The cutting means 44 will be described in more detail hereinafter.

After the semiconductor wafer 20 has been cut as desired in the cutting area 12, the chuck means 36 is returned to the chucking area 8. A third conveying means 46 is provided in relation to the chucking area 8 and the cleaning/drying area 14, and the frame 24 and the semiconductor wafer 20 mounted thereon are carried to the cleaning/drying area 14 by the third conveying means 46. In the cleaning/drying area 14, the cut semiconductor wafer 20 is cleaned and dried by a cleaning/drying means (not shown). Thereafter, the frame 24 and the semiconductor wafer 20 mounted thereon are returned to the waiting area 6 by the second conveying means 34 and then, to the cassette 18 by the first conveying means 32.

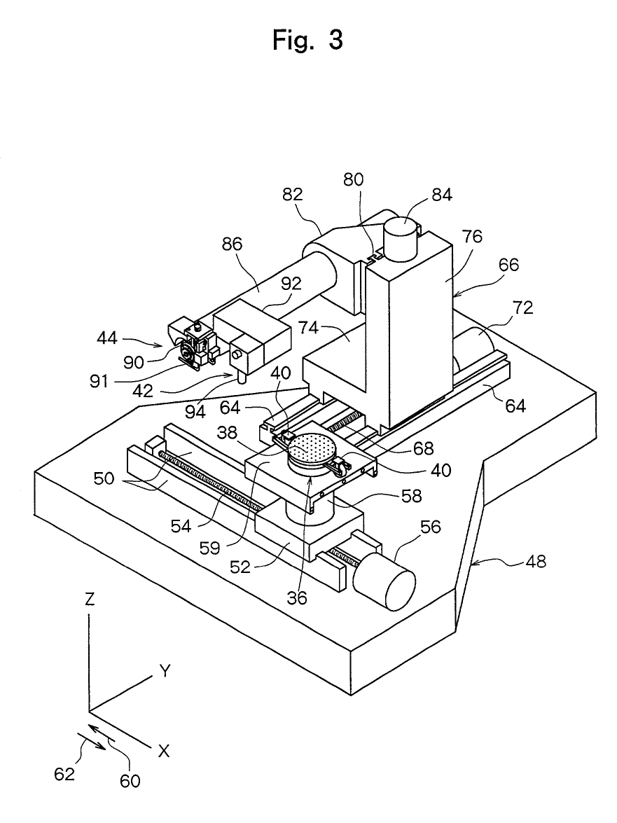

In FIG. 3, the bellows means 41 arranged on the top wall of the housing 2 and both sides of the chuck means 36 are omitted and constituent elements arranged below these are illustrated. Describing with reference to FIG. 1 and FIG. 3, a support base 48 is provided in the housing 2. On this support base 48 are fixed a pair of guide rails 50 extending in an X-axis direction and a sliding block 52 is mounted on the pair of guide rails 50 in such a manner that it can move in the X-axis direction. A threaded shaft 54 extending in the X-axis direction is rotatably mounted between the pair of guide rails 50 and is coupled to the output shaft of a pulse motor 56. The sliding block 52 has a pendent portion (not shown), an internally threaded hole penetrating through the pendent portion in the X-axis direction is formed in the pendent portion, and the threaded shaft 54 is screwed into the internally threaded hole. A support table 59 is fixed on the sliding block 52 via a cylindrical member 58, and further the chuck means 36 is mounted on the support table 59. Therefore, when the pulse motor 56 is turned forward, the support table 59 and the chuck means 36 are moved in a cutting direction indicated by an arrow 60, while when the pulse motor 56 is turned reverse, the support table 59 and the chuck means 36 are moved in a return direction indicated by an arrow 62. Accordingly, the pulse motor 56 constitutes a first moving means for moving the chuck means 36 in the first direction which is the X-axis direction. The chuck plate 38 and the pair of holding means 40 constituting the chuck means 36 are mounted such that they can turn on the center axis extending in a substantially vertical direction, and a pulse motor (not shown) for turning the chuck plate 38 and the pair of holding means 40 is provided in the cylindrical member 58.

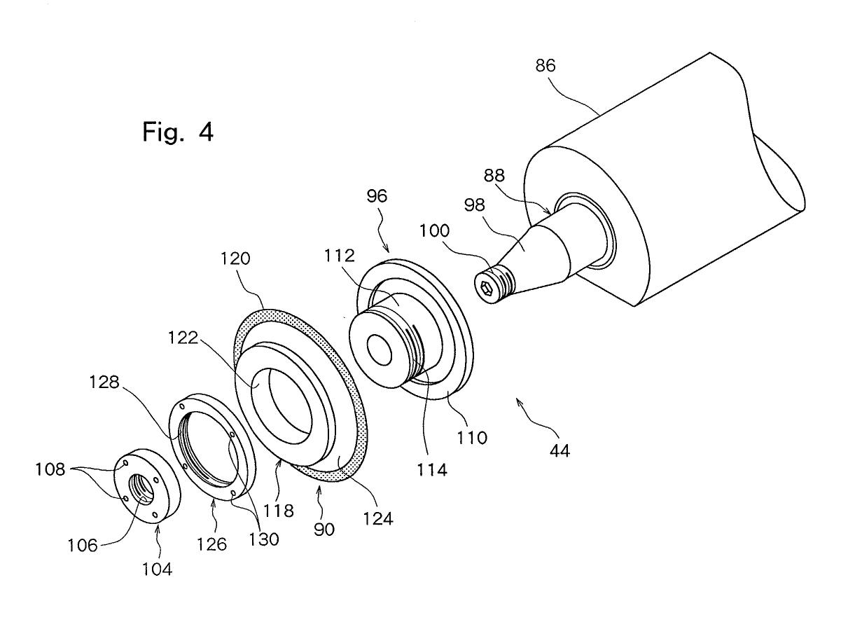

A pair of guide rails 64 extending in the second direction perpendicular to the first direction, that is, in a Y-axis direction are also secured on the support base 48, and a sliding block 66 is mounted on the pair of guide rails 64 in such a manner that it can move in the Y-axis direction. A threaded shaft 68 extending in the Y-axis direction is rotatably mounted between the pair of guide rails 64 and is coupled to the output shaft of a pulse motor 72. The sliding block 66 is substantially shaped like letter L and has a horizontal base portion 74 and an upright portion 76 extending upward from the horizontal base portion 74. A pendent portion (not shown) that hangs down is formed on the horizontal base portion 74, an internally threaded hole penetrating through the pendent portion in the Y-axis direction is formed in the pendent portion, and the threaded shaft 68 is screwed into the internally threaded hole. A pair of guide rails 80 (FIG. 3 shows only an upper end of one of the guide rails 80) extending in the third direction perpendicular to the first direction and the second direction, that is, in a Z-axis direction are formed on the upright portion 76 of the sliding block 66. A coupling block 82 is mounted on the pair of guide rails 80 in such a manner that it can move in the Z-axis direction. A threaded shaft (not shown) extending in the Z-axis direction is rotatably mounted on the upright portion 76 of the sliding block 66 and is coupled to the output shaft of a pulse motor 84. A projecting portion (not shown) projecting toward the upright portion 76 of the sliding block 66 is formed on the coupling block 82, an internally threaded hole penetrating through the projecting portion in the Z-axis direction is formed in the projecting portion, and the above threaded shaft extending in the Z-axis direction is screwed into the internally threaded hole. The above-described cutting means 44 is attached to the coupling block 82. The cutting means 44 has a casing 86 secured to the coupling block 82 and a spindle 88 (FIG. 4) extending in the second direction that is the Y-axis direction is rotatably mounted in the casing 86. A rotating tool 90 is detachably mounted to the spindle 88. The rotating tool 90 is mounted to the spindle 88 by a method of the present invention. The mounting method will be described in detail later. In the casing 86, a motor (not shown) is disposed to rotate the tool 90 at a high speed. A cooling water ejection means 91 for ejecting a cooling liquid which may be pure water is also disposed at an end of the casing 86.

When the pulse motor 72 is turned forward, the sliding block 66 is index-moved forward in the Y-axis direction, whereby the rotating tool 90 is index-moved forward in the Y-axis direction. When the pulse motor 72 is turned reverse, the sliding block 66 is index-moved backward in the Y-axis direction, whereby the rotating tool 90 is index-moved backward in the Y-axis direction. Therefore, the pulse motor 72 constitutes the second moving means for moving the rotating tool 90 in the second direction, that is, in the Y-axis direction. When the pulse motor 84 is turned forward, the coupling block 82 is lowered in the Z-axis direction, whereby the rotating tool 90 is lowered in the Z-axis direction. When the pulse motor 84 is turned reverse, the coupling block 82 is lifted up in the Z-axis direction, whereby the rotating tool 90 is lifted up in the Z-axis direction. Therefore, the pulse motor 84 constitutes the third moving means for moving the tool 90 in the third direction, that is, in the Z-axis direction.

As shown in FIG. 1 and FIG. 3, a support block 92 which projects in the X-axis direction is secured to the above casing 86. A microscope 94 that constitutes the above alignment means 42 is attached to the support block 92. When the chuck means 36 is positioned in the alignment area 10, the chuck means 36 is located below the microscope 94 and an optical image of the surface of the semiconductor wafer 20 held on the chuck means 36 is input into the microscope 94. The optical image 36 is analyzed for aligning one of the streets 28 of the semiconductor wafer 20 with the rotating tool 90 in the Y-axis direction.

The cutting mode of the semiconductor wafer 20 by the rotating tool 90 is summarized as follows. The position in the Y-axis direction of the rotating tool 90 is aligned with one of the streets 28 of the semiconductor wafer 20. The rotating tool 90 is then positioned at a required position in the Z-axis direction, that is, in the cutting position, and the lower end of the circular periphery of the rotating tool 90 is moved up from the reference position in the Z-axis direction by the thickness of the attachment tape 22. Thereafter, the chuck means 36 is moved in a direction indicated by the arrow 60 for cutting. Thus, the semiconductor wafer 20 is cut up to the entire depth thereof along one of the streets without the attachment tape 22 being cut. Then, the rotating tool 90 is lifted upward by a distance larger than the thickness of the semiconductor wafer 20 in the Z-axis direction, and the chuck means 36 is moved in a return direction indicated by the arrow 62. Thereafter, the rotating tool 90 is index-moved in the Y-axis direction and lowered to the cutting position again. The chuck means 36 is then moved in a direction indicated by the arrow 60 for cutting, and cutting is carried out along the next street 28. After the semiconductor wafer 20 is cut along all the plurality of the streets 28 extending in a predetermined direction by carrying out the above cutting repeatedly, the chuck means 36 is turned at 90°. Similar cutting is carried out repeatedly along a plurality of streets 28 extending perpendicular to the streets 28 along which cutting has been already made.

The above constitution of the illustrated cutting machine may not be a novel and may be known to people of ordinary skill in the art. Therefore, a detailed description of the constitution is omitted from the specification of the present invention.

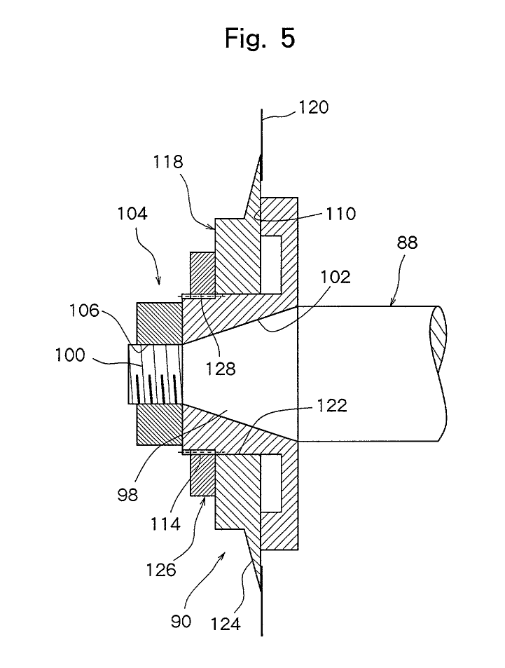

The method of detachably mounting the rotating tool 90 to the spindle 88 of the cutting means 44 will be described in detail with reference to FIG. 4 and FIG. 5. The end portion of the spindle 88 rotatably mounted to the above casing 86 is projected beyond the front end of the casing 86. In the illustrated embodiment, the above rotating tool 90 is mounted to the end portion of the spindle 88 through the aid of a mounting member 96. Describing this in detail, a truncated cone-shaped portion whose diameter is gradually reduced toward the end, namely, a tapered portion 98 is formed at the end portion of the spindle 88, and an external thread 100 is formed on the circumferential surface of a small-diameter cylindrical portion located on the side beyond the end of the tapered portion 98. As clearly shown in FIG. 5, a truncated cone-shaped hole whose inner diameter is gradually increased toward the rear side (right side in FIG. 5), namely, a tapered hole 102 is formed in the center portion of the mounting member 96. The taper angle of the tapered portion 98 of the spindle 88 and the taper angle of the tapered hole 102 of the mounting member 96 are set to substantially the same. The tapered portion 98 of the spindle 88 is fitted into the tapered hole 102 of the mounting member 96. Thereafter, the mounting member 96 is secured to the spindle 88 by screwing a fixing nut 104 onto the external thread 100 of the spindle 88 to forcedly move the mounting member 96 backward (right side in FIG. 5). An internally threaded through hole 106 is formed in the center portion of the ring-shaped fixing nut 104, and four through holes 108 are formed in a circumferential direction with a space therebetween. The engagement pins of a fastening tool (not shown) can be engaged with the through holes 108 of the fixing nut 104 when the fixing nut 104 is screwed onto the external thread 100 of the spindle 88. The fixing nut 104 is firmly screwed onto the external thread 100 of the spindle 88 to forcedly move the mounting member 96 backward, whereby the tapered hole 102 of the mounting member 96 is brought into fully close contact with the tapered portion 98 of the spindle 88, thus making it possible to mount the mounting member 96 concentric to the spindle 88 fully accurately. The spindle 88 and the mounting member 96 mounted thereto may be made of suitable metal such as stainless steel. If desired, the spindle 88 and the mounting member 96 can be integratedly formed as a single unit instead of mounting the mounting member 96 formed separately from the spindle 88 to the spindle 88.

Continuing a description of the present invention with reference to FIG. 4 and FIG. 5, the above mounting member 96 has an annular flange surface 110 facing forward (left side in FIG. 5). This annular flange surface 110 extends substantially perpendicular to the rotation center axis of the spindle 88 and the mounting member 96. A mounting portion 112 having a cylindrical outer circumferential surface is formed on the front side of the annular flange surface. An external thread 114 is formed on the cylindrical outer circumferential surface of the mounting member 96 on the front side of the mounting portion 112.

The rotating tool 90 in the illustrated embodiment comprises a hub 118 and a cutting blade 120. A through hole is formed in the center portion of the hub 118 which is preferably made of suitable metal such as an aluminum-based alloy, and has a cylindrical inner circumferential surface constituting an attachment portion 122. An annular support flange 124 is formed at the rear end (right end in FIG. 5) of the hub 118. Both the back surface (that is, the back surface of the annular support flange 124) and the front surface of the hub 118 extend substantially perpendicular to the center axis of the hub 118. The cutting blade 120 is of an annular form, its inner peripheral portion is secured to the outer peripheral rim portion of the back surface of the annular support flange 124 of the hub 118, and its outer end portion is projected beyond the outer periphery of the annular support flange 124. The cutting blade 120 may be a so-called electroformed blade produced by dispersing diamond grains in a suitable metal such as nickel to be electroplated on the annular support flange 124 of the hub 118.

In the present invention, it is important that the outer diameter D1 at normal temperatures of the mounting portion 112 of the mounting member 96 mounted to the spindle 88 be made slightly larger than the inner diameter D2 of the attachment portion 122 of the hub 118 of the rotating tool 90. The difference (D1−D2) between the outer diameter D1 and the inner diameter D2 at normal temperatures may be about 0.1 to 1 μm. When the rotating tool 90 is to be mounted to the mounting member 96, the attachment portion 122 of the hub 118 of the rotating tool 90 is heated to be thermally expanded and/or the mounting portion 112 of the mounting member 96 is cooled to be thermally shrunk in order to make the inner diameter D2 of the attachment portion 122 of the hub 118 substantially the same or slightly larger than the outer diameter D1 of the mounting portion 112 of the mounting member 96. In this state, the attachment portion 122 of the hub 118 is fitted onto the mounting portion 112 of the mounting member 96. Then, when the attachment portion 122 of the hub 118 and/or the mounting portion 112 of the mounting member 96 are/is returned to ordinary temperature, the attachment portion 122 is fully tightly fitted to the mounting portion 112 due to the thermal shrinkage of the attachment portion 122 and/or the thermal expansion of the mounting portion 112, and the rotating tool 90 is mounted concentric to the mounting member 96 (accordingly to the spindle 88) fully accurately and fully firmly. When the rotating tool 90 must be exchanged due to the abrasion or the like of the cutting blade 120 of the rotating tool 90, the attachment portion 122 of the hub 118 of the rotating tool 90 is heated to be thermally expanded, and/or the mounting portion 112 of the mounting member 96 is cooled to be thermally shrunk in order to make the inner diameter D2 of the attachment portion 122 of the hub 118 substantially the same or slightly larger than the outer diameter D1 of the mounting portion 112 of the mounting member 96, whereby the rotating tool 90 can be removed from the mounting member 96 very easily.

In the illustrated embodiment, in order to reliably prevent the rotating tool 90 from being accidentally removed from the mounting member 96 after the rotating tool 90 has been mounted to the mounting member 96 as described above, a fixing nut 126 is screwed onto the external thread 114 of the mounting member 96 to interpose the rotating tool 90 between the annular flange surface 110 of the mounting member 96 and the fixing nut 126. A through internal thread 128 is formed on the center portion of the ring-shaped fixing nut 126, and four through holes 130 are formed in a circumferential direction with a space therebetween. The engagement pins of a fastening tool (not shown) can be engaged with the through holes 130 of the fixing nut 126 to screw the fixing nut 126 onto the external thread 114 of the mounting member 96.

A tapered portion and a tapered hole may be used to mount the rotating tool 90 concentric to the mounting member 96 fully accurately in the same manner as when the mounting member 96 is mounted to the spindle 88. However, according to the experience of the inventor of the present invention, it has been revealed that in the case where this mounting method making use of a tapered portion and a tapered hole is employed, if the cutting machine is continued to be used, so-called bite between the mounting member 96 and the rotating tool 90 is produced, thereby making it extremely difficult to remove the rotating tool 90 from the mounting member 96. Since the mounting member 96 does not need to be removed from the spindle 88, there will be no problem even if so-called bite between the spindle 88 and the mounting member 96 is formed.

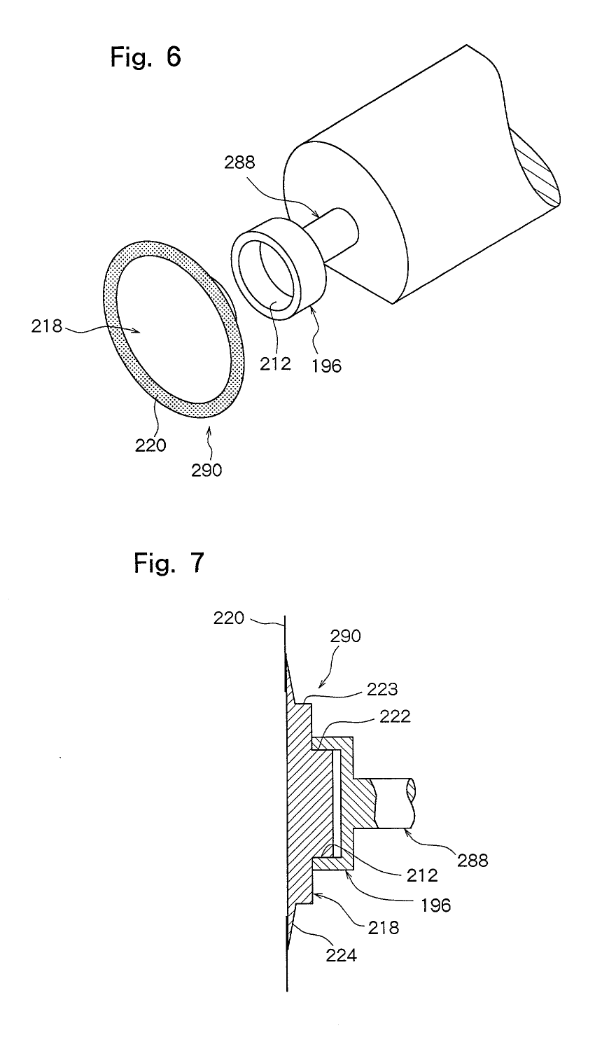

FIG. 6 and FIG. 7 show another embodiment of the method of the present invention. In the method shown in FIG. 6, a mounting portion 212 is formed integratedly with a spindle 288. Describing this in more detail, the spindle 288 is provided with a cylindrical end portion 196 having a relatively large diameter and a concavity constituting the mounting portion 212 is formed in the front surface of the end portion 196. The cross sectional shape of the concavity constituting the mounting portion 212 is circular, and the mounting portion 212 has a cylindrical inner circumferential surface. A rotating tool 290 comprises a hub 218 and a cutting blade 220. The hub 218 has a cylindrical attachment portion 222 having a relatively small diameter, a cylindrical intermediate portion 223 and an annular support flange 224, which are positioned in this order from the rear to the front. The cutting blade 220 is of an annular form and its inner peripheral portion is secured to the peripheral rim portion of the front surface of the annular support flange 224, while its outer peripheral portion is projected beyond the outer periphery of the annular support flange 224. It is important that the inner diameter D1 at normal temperatures of the mounting portion 212 of the spindle 288 be made slightly smaller than the outer diameter D2 at normal temperatures of the attachment portion 222 of the rotating tool 290. The difference (D2−D1) between the inner diameter D1 and the outer diameter D2 at normal temperatures may be about 0.1 to 1 μm. To mount the rotating tool 290 to the mounting portion 212 of the spindle 288, the attachment portion 222 of the hub 218 of the rotating tool 290 is cooled to be thermally shrunk, and/or the mounting portion 212 of the spindle 288 is heated to be thermally expanded, whereby the outer diameter D2 of the attachment portion 222 of the hub 218 is made substantially the same or slightly smaller than the inner diameter D1 of the mounting portion 212. In this state, the attachment portion 222 of the hub 218 is fitted into the mounting portion 212 of the spindle 288. Then, when the attachment portion 222 of the hub 218 and/or the mounting portion 212 of the spindle 288 are/is returned to ordinary temperature, the attachment portion 222 is fully tightly fitted to the mounting portion 212 due to the thermal expansion of the attachment portion 222 and/or the thermal shrinkage of the mounting portion 212. Thus, the rotating tool 290 is mounted concentric to the mounting portion 212 of the spindle 288 fully accurately and fully firmly. When the rotating tool 290 must be exchanged due to the abrasion or the like of the cutting blade 220 of the rotating tool 290, the attachment portion 222 of the hub 218 of the rotating tool 290 is cooled to be thermally shrunk and/or the mounting portion 212 of the spindle 288 is heated to be thermally expanded to make the outer diameter D2 of the attachment portion 222 of the hub 218 substantially the same or slightly smaller than the inner diameter D1 of the mounting portion 212 of the spindle 288. Then, the rotating tool 290 can be removed from the spindle 288 very easily.

While preferred embodiments of the present invention have been described in detail with reference to the accompanying drawings, it is to be understood that the present invention is not limited thereto and various changes and modifications may be made without departing from the spirit and scope of the invention.

What is claimed is:

1. A method of detachably mounting a rotating tool provided with an attachment portion having a cylindrical inner circumferential surface to a mounting portion having a cylindrical outer circumferential surface of a spindle, comprising the steps of:
making the inner diameter at normal temperatures of the attachment portion smaller than the outer diameter at normal temperatures of the mounting portion; and
heating the attachment portion and/or cooling the mounting portion to make the inner diameter of the attachment portion larger than the outer diameter of the mounting portion so as to fit the attachment portion onto the mounting portion.

2. The method of claim 1, wherein at least the mounting portion of the spindle is made of metal.

3. The method of claim 1, wherein at least the attachment portion of the rotating tool is made of metal.

4. The method of claim 1, wherein the rotating tool comprises a metal hub and a thin annular cutting blade secured to the hub, the hub being provided with the attachment portion and the cutting blade containing diamond grains.

5. A method of detachably mounting a rotating tool provided with an attachment portion having a cylindrical outer circumferential surface to a mounting portion having a cylindrical inner circumferential surface of a spindle, comprising the steps of:
making the outer diameter at normal temperatures of the attachment portion larger than the inner diameter at normal temperatures of the mounting portion; and
cooling the attachment portion and/or heating the mounting portion to make the outer diameter of the attachment portion smaller than the inner diameter of the mounting portion so as to fit the attachment portion into the mounting portion.

6. The method of claim 5, wherein at least the mounting portion of the spindle is made of metal.

7. The method of claim 5, wherein at least the attachment portion of the rotating tool is made of metal.

8. The method of claim 5, wherein the rotating tool comprises a metal hub and a thin annular cutting blade secured to the hub, the hub being provided with the attachment portion and the cutting blade containing diamond grains.
